(19) United States
(12) Patent Application Publication
(10) Pub. No.: US 2006/0149620 A1
(43) Pub. Date: Jul. 6, 2006

(54) On-line fundraising method, system, and computer useable medium

(76) Inventors: Keith M. Reed, Newtown, PA (US); Al D. Arevalo, Newtown, PA (US); John P. Henderson, Wycombe, PA (US); Michael J. McGovern, Princeton Junction, NJ (US)

Correspondence Address: LITMAN LAW OFFICES, LTD, PO BOX 15035, CRYSTAL CITY STATION, ARLINGTON, VA, 22215, US

(21) Appl. No.: 11/025,248

(22) Filed: Dec. 30, 2004

(51) Int. Cl. G06Q 30/00; G06Q 40/00

(52) U.S. Cl. 705/14; 705/26; 705/35

(57) ABSTRACT

An on-line fundraising method, system, and/or computer useable medium provides a fundraising website, fundraising software, and a fundraising database for a fundraiser. Fundraiser organizations are associated with a fundraising website as fundraiser associates. Retail partners are affiliated with the fundraising website. Users are referred to the fundraising website by a fundraiser associate. Products and/or services are sold on the fundraising website from an affiliated retail partner on the fundraising website. Funds are provided to the referring fundraiser associate for the fundraiser based on the products and/or services sold. The website provides web enabled affiliate network fundraising. A first drop down box is provided on the website to identify an organization who referred a user to the fundraising website. A second drop down box is provided to identify a local chapter associated with the organization. Products that are sold on the fundraising website can be tracked for fundraiser associates.

### BACKGROUND OF THE INVENTION

1. Field of the Invention

The present invention generally relates to fundraising and, more particularly to an on-line fundraising method, system and/or computer useable medium.

2. Description of Related Art

Fundraising is an organized activity or instance of soliciting money or pledges for organizations, such as charitable organizations, political campaigns, etc. Successful fundraising is achieved through garnering the support of increasingly diverse populations of volunteers, leaders, and donors. Common problems that result in static or declining fundraising revenues include lack of planning, repeating the same old fundraiser, not recruiting enough help, inadequate sales preparation, poor support materials, no sales script, weak internal communication, lack of publicity, continuous fundraising, bad timing, no rewards, poor rewards, letting problems fester, picking the wrong fundraiser, etc.

Typically, a fundraising workforce is based on a core volunteer group. Good people who are willing to help a cause at no cost are hard to find and overworking the core volunteer group is a recipe for disaster. Efforts to increase the volunteer group include defining all the roles and responsibilities, providing written descriptions of what is expected from each support role, including an accurate estimate of the time each position requires, breaking volunteer time blocks into two, four, or eight hour chunks, allowing job sharing, etc. Defining how much time a support position requires increases the likelihood of a match with potential volunteers. However, obtaining a motivated fundraising workforce continues to be a never ending need amongst fundraisers.

Marketing success over the internet has surged over the past several years. Two of today's most powerful and fastest growing business areas are affiliate marketing and network marketing. Internet affiliate marketing operates on the internet using websites that track sales and commissions for their affiliate partner websites. The websites are developed by or for a merchant in order to generate incremental sales and leads based on a pay-per-lead and/or revenue sharing model. For example, if an individual wants to sell books on their website, they could become an affiliate partner for Amazon.com, the large bookselling website. Amazon.com then provides a hyperlink that can be embedded into the individual's website with which the individual could promote books. The hyperlink is manifest as a word in a text field or an image on a web page of the website, and acts as a path, moving a user from one web page address, known as a Uniform Resource Locator (URL), to another web page address. When anyone clicks on the embedded hyperlink and buys books from Amazon.com, the individual receives a flat fee per purchase and/or a commission on the purchase from Amazon.com.

Network marketing is based on building a network of independent contractors who receive compensation only when they sell a product directly, or through referral, usually to individuals who they have a personal relationship with, or were referred to through another personal relationship. Internet affiliate marketing programs are known for creating websites that do the selling and training for the marketers because there is no personal interaction. Network marketing includes known marketing techniques, such as the use of flyers, newspaper advertisements, magazine advertisements, etc. Fundraising success could be improved if the strengths of internet affiliate marketing and network marketing were combined to provide organizations with a new approach to fundraising. Therefore, a need exists to provide an on-line fundraising method, system and/or computer useable medium solving the aforementioned problems.

### SUMMARY OF THE INVENTION

The present invention is an on-line fundraising method, system and/or computer useable medium. The fundraising method provides a fundraising website, fundraising software, and a fundraising database for a fundraiser. Fundraiser organizations are associated with the fundraising website as fundraiser associates. Retail partners are affiliated with the fundraising website. Users are referred to the fundraising website by a fundraiser associate. Products and/or services are sold on the fundraising website for the fundraiser. Funds are provided to the referring fundraiser associate for the fundraiser based on the products and/or services sold on the website. The website provides web enabled affiliate network fundraising. A first drop down box is provided on the website to identify an organization who referred a user to the fundraising website. A second drop down box is provided to present the user with a list of local chapters associated with the organization. Products that are sold on the fundraising website can be tracked for fundraiser associates.

### BRIEF DESCRIPTION OF THE DRAWINGS

FIG. 1 is a diagram of an on-line fundraising system according to the present invention.

FIG. 2 is a diagram of a computer device configured for use with an on-line fundraising system according to the present invention.

FIG. 3 is a page image of an on-line fundraising system website example according to the present invention.

FIG. 4 is a page image of an on-line fundraising system website example according to the present invention.

FIG. 5 is a page image of an on-line fundraising system website example according to the present invention.

Similar reference characters denote corresponding features consistently throughout the attached drawings.

### DETAILED DESCRIPTION OF THE PREFERRED EMBODIMENTS

The present invention is an on-line fundraising method, system, and/or computer useable medium. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

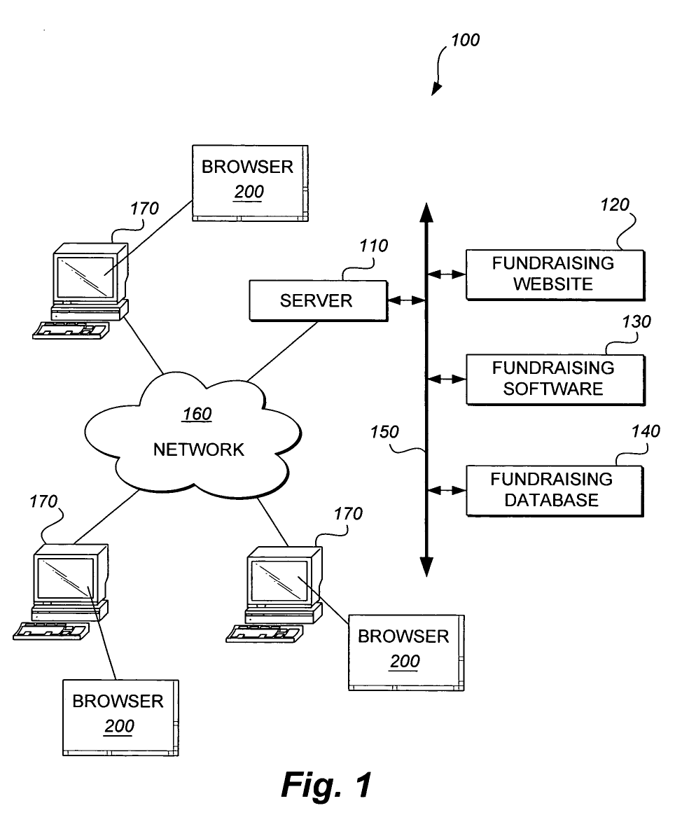

Referring to the drawings, FIG. 1 shows a fundraising system 100 according to the invention where a variety of user computers 170 may interconnect via browsers 200 with a fundraising website 120 over a network 160. The fundraising website 120 is administered by a server 110, fundraising software 130, and a fundraising database 140. The fundraising website 120, fundraising software 130, and the fundraising database 140 are interconnected via a communication bus 150.

The fundraising system 100 is configured to provide web enabled affiliate network fundraising. The fundraising system 100 provides fundraising capability at anytime for a non-profit and/or any other charitable organization in a web based, “paperless” fashion. Non-profit and/or any other charitable referral fundraiser associate organizations are provided with the opportunity to deliver multiple fundraising campaigns, with multiple different products and services, all from a single web page. The fundraising system 100 facilitates the creation of a very large, highly motivated, network of people, at the local level of national organizations, to refer prospects to the fundraising website 120 via contractual agreements executed at their local and/or national level (e.g., the local, national, and/or governing body level.

The fundraising system 100 provides the seamless integration of a referral organization database with the full featured tracking, reporting, and commissioning infrastructure of fundraiser associates by the fundraising system 100. Inventory or customer support by the fundraising system 100 is unnecessary for purchases made on the fundraising website 120 because everything is handled by affiliate retail partners of the fundraising website 120.

The server 110 includes stored therein fundraising software 130. The fundraising software 130 may be stored in the memory of the server 110, and may be any combination of random access memory or cache memory. The fundraising software 130 includes a plurality of computer instructions and may additionally be carried on any computer useable medium according to the desires of the user, such as a computer hard drive, a floppy disk, Flash memory, optical memory, magnetic media memory, or the like. The server 110 includes a processor, an operating system, application programs, and data. In accordance with well known principles, the processor executes the applications in the memory of the server 110 under control of the operating system.

The fundraising software 130 can be configured to provide and/or combine functions associated with affiliate marketing and network marketing techniques. For example, the fundraising software 130 can be configured to create a new account for fundraiser associates by providing them with a username and a password, to check the status of an existing account, to request an informational email, to put a lost account identification or HTML on the website 120, to provide a lost account name, to provide a lost account password, to provide fundraiser associate personal information, to provide accounting detail, to provide a traffic report, to provide a payout report, to provide an orders report, to provide account options, to provide a main entry for fundraiser associates, etc. The flat fee and/or percentage paid per purchase to each fundraiser associate can be customized.

An unlimited number of fundraiser associates can be implemented by the website 120. A customizable welcome email to fundraiser associates can be provided. Notification can be made for fundraiser associate sign ups. Maintenance can be made for personal details. Fundraiser associate accounts can be deleted. Miscellaneous credits or debits can be made to any account. The fundraiser associates can track any amount of individual fundraising campaigns under a single account. Real time reports by day, month, fundraiser associate, and a fundraiser can be sorted by column, and summaried. The fundraising software 130 can track any of the fundraising campaigns.

The fundraising website 120 is a collection of files stored on the server 100 that is connected to a network 160. The network 160 can be the World Wide Web which is a collection of websites whose servers are interconnected through the internet. A collection of fundraising websites 120 can also be stored on servers 110 that are interconnected through a private network, e.g., through an intranet. In many cases, at least some of the files of the website 120 contain hyperlinks. A hyperlink is typically a text, graphic, or image object in a first file that, when selected by a user, either causes a second file to be displayed to the user, causes a different part of the first file to be displayed to the user, or executes a program. In this way, a file in the website 110 can be interrelated with another file stored at the same website, a different website, or elsewhere. The interrelated files of the fundraising website 120 can reflect a common theme, such as information about a particular company, activity, or service.

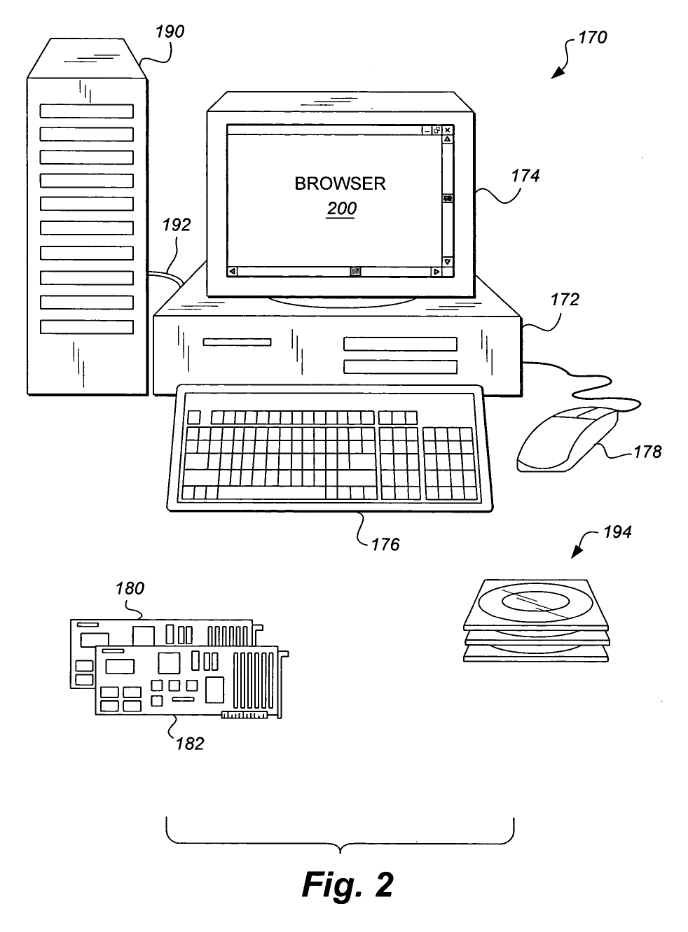

FIG. 2 shows details of a computer arrangement 170 configured for use with the fundraising system 100. The arrangement 170 includes a computer device 172, a monitor 174, a keyboard 176, and a mouse 178. The computer device 172 is interconnected with a memory storage unit 190 via a cable 192 or other linking device, and can be configured to be used with memory in the form of computer useable mediums, such as memory boards 180, 182, with removable memory elements 194 (e.g., CD-ROMS, floppy disks, etc.), or the like. The computer device 172 may be configured in the form of any type of computer as desired, such as a desktop computer, a laptop computer, a palmtop computer, a network computer, a personal digital assistant (PDA), a BlackBerry, a cell phone, an embedded device, a smart phone, or any other suitable computer device.

As used herein, a “computer useable medium” includes a non-volatile medium, a volatile medium, and/or an installation medium. A non-volatile medium may be a magnetic medium, hard disk, a solid state disk, optical storage, Flash memory, electrically eraseable programmable read only memory (EEPROM), parameter random access memory (PRAM), etc. A volatile medium may be dynamic RAM (DRAM), Direct Rambus® DRAM (DRDRAM), double-data rate DRAM (DDR DRAM), double-data rate synchronous DRAM (DDR SDRAM), enhanced DRAM (EDRAM), enhanced synchronous DRAM (ESDRAM), extended data out (EDO) DRAM, burst EDO (BEDO) DRAM, fast page mode DRAM (FPM DRAM), Rambus DRAM (RDRAM), SyncLink® DRAM (SLDRAM), synchronous RAM (SRAM), synchronous DRAM (SDRAM), synchronous graphic RAM (SGRAM), video RAM (VRAM), window RAM (WRAM), etc. An installation medium may be a CD-ROM, a DVD, a DVD-R, a DVD+R, a DVD-RW (writable), a DVD+RW (writable), a floppy disk, a removable disk, etc., on which computer programs are stored for loading into a computer device.

The computer device 172 may wirelessly or non-wirelessly interconnect to the fundraising website 120 through the use of a browser 200 via any known technique (e.g., wireless local area network (LAN), IrDA, BlueTooth, FireWire, etc.) or through a network system via any number of switches, such as a LAN, a wide area network (WAN), an intranet, an extranet, the internet, etc., to enable a user to wirelessly or non-wirelessly access the fundraising website 120 through appropriate control signals.

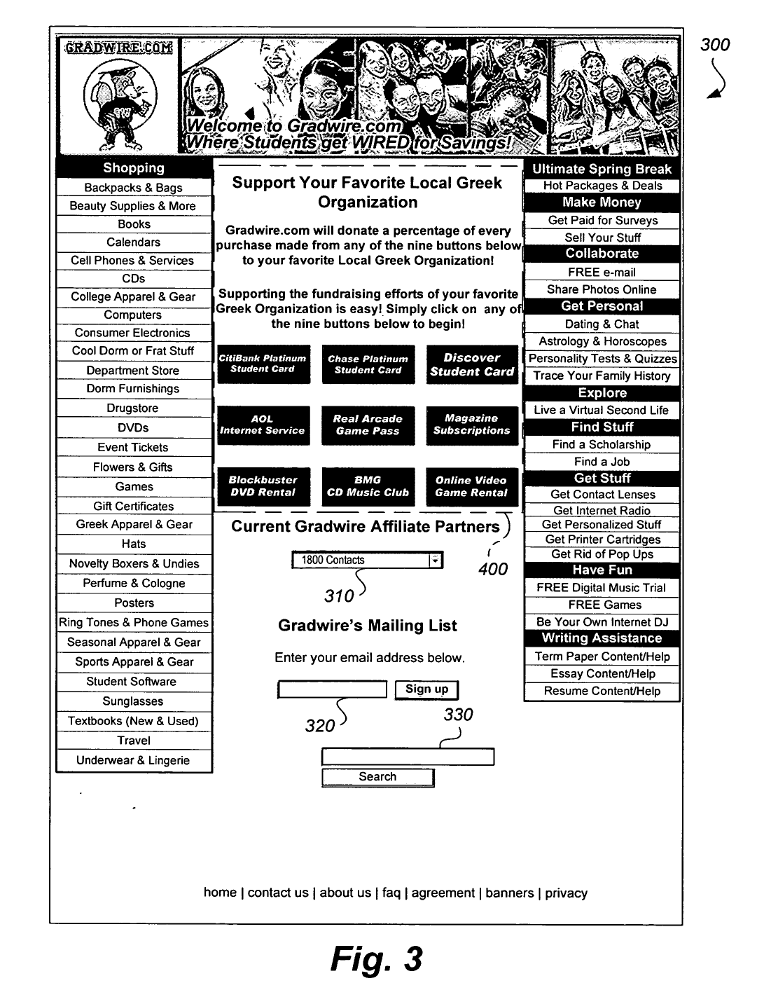

FIG. 3 shows an example of a webpage 300 which may be placed on the fundraising website 120. The webpage 300 is configured for a particular demographic audience that the fundraising organization wants to target for fundraising. In this instance, the webpage 300 is configured for national college fraternities and/or sororities. However, while the webpage 300 is preferably configured for use with very large, highly geographically dispersed, but centrally managed fundraiser organizations, such as the Boy Scouts, the Girl Scouts, etc., the webpage 300 may be configured for any type of organization. The webpage 300 is a single page, with a layout having a plurality of buttons.

The buttons to the left and right of the webpage 300 are conventional website buttons that provide hyperlinks to conventional retail affiliate partners who provide goods and/or services to users. These buttons provide no flat fees and/or commissions for fundraiser associates. At the bottom of the webpage 300 are several hyperlinks including HOME, CONTACT US, ABOUT US, FAQ, AGREEMENT, BANNERS, and PRIVACY. With the exception of the AGREEMENT hyperlink, these hyperlinks are conventional. The AGREEMENT hyperlink provides fundraiser organizations to become associated with the webpage 300 and become fundraiser associates with the webpage 300. Interested fundraiser organizations are presented with an AGREEMENT via one or more web pages. The AGREEMENT sets forth a predetermined flat fee and/or percentage to be paid per executed monetary transaction for a product and/or service to the fundraiser organization once the fundraiser organization has executed the AGREEMENT. An agreement for a particular fundraiser organization can be customized to the particular fundraiser associate. Fundraiser associates who have executed the agreement with the website 120 can then receive flat fees and/or percentages per purchase by providing manpower and referring users to the webpage 300 to make a transaction using one or more of the middle buttons 400.

The buttons 400 in the middle of the webpage 300 provide hyperlinks to products and/or services of affiliate retail partners who have authorized the website 120 to include their hyperlinks on the webpage 300. Such affiliate retail partners provide authorization with the website 120 through conventional third party websites who track actual purchases and/or services made through clicking on the hyperlink on the webpage 300. The fundraising software 130 also tracks and stores data regarding particular fundraiser associates who cause such clicks and purchases to take place from the website 120. For each purchase of a product or service using any of these buttons 400, the corresponding fundraiser associate receives a predetermined flat fee and/or commission in accordance with the agreement they executed with the website 120. A user may visit the fundraising website 120 after being referred by a participating fundraiser associate, such as a non-profit and/or any other charitable organization or the like.

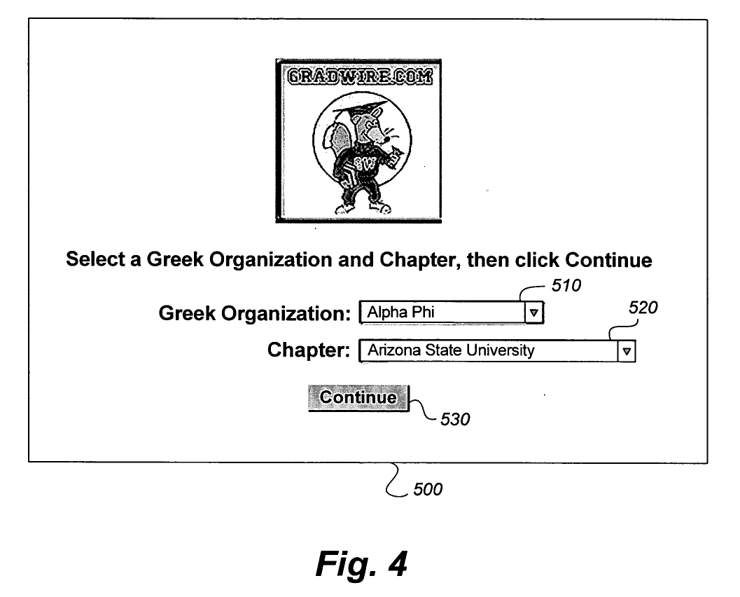

On the webpage 300 users can click on one of the middle buttons 400 and are provided with the webpage 500 shown in FIG. 4. After locating and selecting a particular fundraiser referring organization in the first drop down box 510, the user locates and selects a particular chapter associated with the fundraiser organization in the second drop down box 520. On the webpage 300, the drop down box 310 provides a list of all affiliate retail partners on the website 120. An entry box 320 is provided to enable visitors to provide their email addresses to be included on the mailing list of the website 120. In addition, a search box 330 is provided to enable visitors to the webpage 300 to conduct web searches.

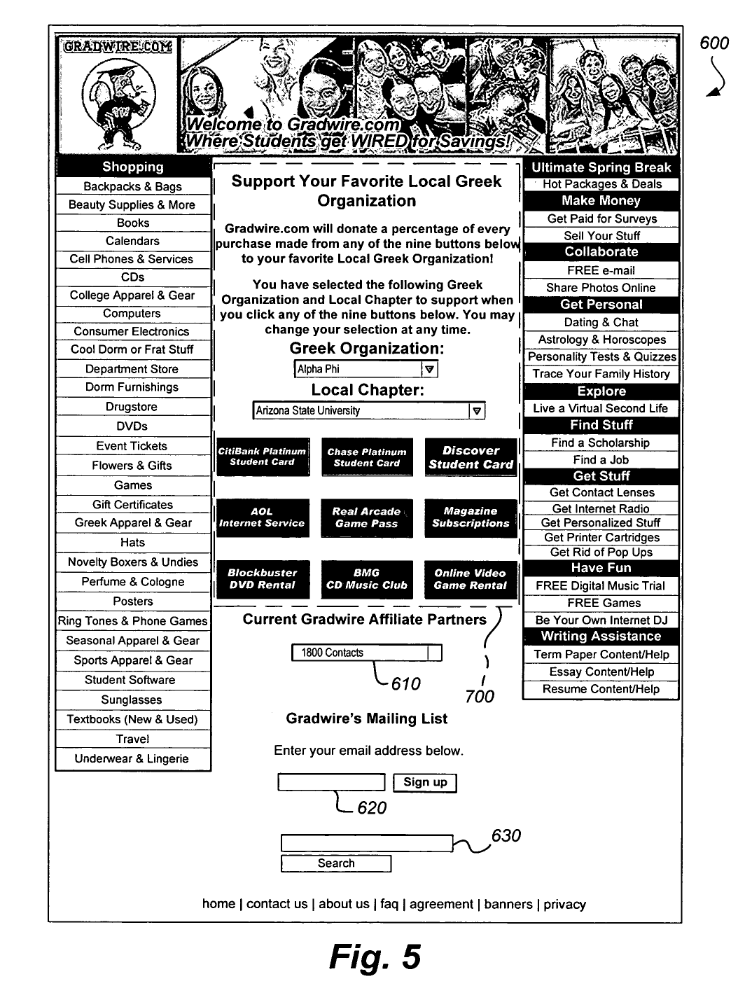

Once a user from a particular computer locates and selects a particular fundraiser associate and chapter, subsequent visits to the website 120 provide the user with the webpage 600 shown in FIG. 5 which automatically provides the fundraiser associate and chapter previously selected. This selection can be altered as desired by clicking through the associated drop down boxes. The drop down box 610 provides a list of all affiliate retail partners on the website 120. The entry box 620 is provided to enable visitors to provide their email addresses to be included on the mailing list of the website 120. In addition, a search box 630 is provided to enable visitors to the webpage 600 to conduct web searches. Each local chapter can have a unique identifier number associated with it, so when their individual finds and chooses the appropriate local organization and clicks on it that unique identifier is automatically placed in the URL of the webpage or browser.

When the individual clicks into one of the fundraising buttons 400 or 700 to purchase a product and/or service in support of the fundraiser associate that referred them, the complete URL, including the unique identifier, is captured by the retail affiliate partner and can be tracked for receiving an associated flat fee and/or commission. This information is tracked and stored on the fundraiser database 140. The group of buttons on the center of the webpage 400 or 700 can be products and/or services to be utilized for fundraising campaigns. These may be the only products and/or services utilized for fundraising campaigns. These products and/or services can be tracked and the fundraiser associates can be provided with a flat fee and/or commissioned for referring prospects to this section of the webpage 400 or 700. The buttons going up and down and left and right sides are for products and/or services the target audience may be interested in using or buying and provide no flat fee and/or commission to any fundraiser associate with the website 120.

Each fundraising website 120 can be built to target the buying interests of the prospects of the fundraiser associates that are targeted to raise funds. A large and motivated referral network of fundraiser organization members from local chapters/offices/locations throughout the country can be generated by executing contractual agreements at the national and/or local level of each of their respective organizations. Immediately following the contract signing of a national and/or local organization, the fundraising opportunity can be marketed to each of the local chapters/offices/locations associated with the national and/or local organization.

Each participating organization can raise funds for their local chapter, national office and/or overall governing body by simply referring friends, family, colleagues, fellow workers, or relationships of any kind to the website 120 by simply pressing on the appropriate button, being taken to the fundraiser associate website, and then executing a transaction. Each qualified transaction is tracked at their local chapter level and commissioned to the referring organization, its national office, local office, governing body, etc., after the affiliate retail partner has commissioned the website. The infrastructure needed to track, report, commission, etc., is provided by the affiliate retail partner. The products and services offered in the fundraising section of the website 120 can be chosen for their appeal to the target demographic population at large, for a low price point (free trial offers can also be provided), and for the ability to be marketed in discrete fundraising campaigns. The additional products and services offered on the website 120 built around the fundraising section, also chosen for target population appeal, do not need to pay commissions to any other organization.

The on-line fundraising method, system and/or computer useable medium provides a fundraising website, fundraising software, and a fundraising database for a fundraiser. Fundraiser organizations are associated to the fundraising website 120 for the fundraiser. Products and/or services are sold on the fundraising website for the fundraiser. Funds are provided for the fundraiser based on the products and/or services sold for the fundraiser. The website 120 provides web enabled affiliate network fundraising. A first drop down box is provided on the website to identify a fundraiser associate who referred a user to the fundraising website 120. A second drop down box is provided to present the user with a list of local chapters associated with the fundraiser associate. Products and/or services that are sold on the fundraising website 120 can be tracked for the fundraiser associate.

The fundraising system 100 motivates through monetary incentive a large group of geographically dispersed people (independent contractors), who are all part of the same organization (centrally managed and contracted), by providing them a simple way to refer their fundraising prospects to a single place where they can get a product or service they want, tracking the transactions at the local level throughout the infrastructure provided by the affiliate retail partner, and paying them a flat fee and/or commissioning them at the local, national, and/or governing body level. The fundraising system 100 is a win, win, win for fundraiser associates, affiliate retail partners, and website owners/operators. The fundraiser system 100 also provides a unique method of driving traffic to a website to help facilitate traditional online business/transactions.

The fundraising system 100 provides web enabled affiliate network fundraising. The fundraising system 100 provides fundraising capability at anytime for a non-profit and/or any other charitable organization in a web based, paperless fashion. Non-profit and/or any other charitable referral associates are provided with the opportunity to deliver multiple fundraising campaigns, with multiple different products and/or services, all from a single web page. The fundraising system 100 facilitates the creation of a very large, highly motivated, network of people, at the local level of national organizations, to refer prospects to the fundraising website 120 via contractual agreements executed at their national and/or local level (e.g., the local, national, and/or governing body level).

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

We claim:

1. A fundraising method comprising:
providing a fundraising website, fundraising software, and a fundraising database for a fundraiser;
associating fundraiser organizations to the fundraising website as fundraiser associates;
affiliating retail partners to the fundraising website;
referring users to the fundraising website by a fundraiser associate;
selling at least one of products and services on the fundraising website from an affiliated retail partner on the fundraising website; and
providing funds to the referring fundraiser associate for the fundraiser based on the products and services sold on the fundraising website.

2. The fundraising method according to claim 1, further comprising:
providing web enabled affiliate network fundraising.

3. The fundraising method according to claim 1, further comprising:
providing a first drop down box on the website to identify an organization who referred a user to the fundraising website.

4. The fundraising method according to claim 3, further comprising:
providing a second drop down box to presents the user with a list of local chapters associated with the organization.

5. The fundraising method according to claim 1, wherein said selling at least one of products and services step further comprises:
selling a product on the fundraising website for the fundraiser.

6. The fundraising method according to claim 1, wherein said selling at least one of products and services step further comprises:
selling a service on the fundraising website for the fundraiser.

7. The fundraising method according to claim 1, further comprising:
tracking products that are sold on the fundraising website for the fundraiser employing a browser graphical user interface.

8. A fundraiser system comprising:
a server with a processor;
a fundraiser website for a fundraiser;
a fundraiser software;
a fundraiser database;
wherein said fundraiser software, when executed by the processor, causes the processor to carry out the steps comprising;
associating fundraiser organizations to a fundraising website as fundraiser associates;
affiliating retail partners to the fundraising website;
referring users to the fundraising website by a fundraiser associate;
selling at least one of products and services on the fundraising website from an affiliated retail partner on the fundraising website; and
providing funds to the referring fundraiser associate for the fundraiser based on the products and services sold on the fundraising website.

9. The fundraising system according to claim 8, wherein said fundraising system is configured to provide web enabled affiliate network fundraising.

10. The fundraising system according to claim 8, wherein said fundraiser software further causes the processor to carry out the steps comprising:
providing a first drop down box on the website to identify an organization who referred a user to the fundraising website.

11. The fundraising system according to claim 10, wherein said fundraiser software further causes the processor to carry out the steps comprising:
providing a second drop down box to presents the user with a list of local chapters associated with the organization.

12. The fundraising system according to claim 8, wherein said selling at least one of products and services step further comprises:
selling a product on the fundraising website for the fundraiser.

13. The fundraising system according to claim 8, wherein said selling at least one of products and services step further comprises:
selling a service on the fundraising website for the fundraiser.

14. The fundraising system according to claim 8, wherein said fundraiser software further causes the processor to carry out the steps comprising:
tracking products that are sold on the fundraising website for the fundraiser.

15. A computer useable medium carrying fundraiser software which, when executed by a processor, causes the processor to carry out steps comprising:
associating fundraiser organizations to the fundraising website as fundraiser associates;
affiliating retail partners to the fundraising website;
referring users to the fundraising website by a fundraiser associate;
selling at least one of products and services on the fundraising website from an affiliated retail partner on the fundraising website; and
providing funds to the referring fundraiser associate for the fundraiser based on the products and services sold on the fundraising website.

16. The computer useable medium according to claim 15, wherein said fundraising website is configured to provide web enabled affiliate network fundraising.

17. The computer useable medium according to claim 15, wherein said fundraiser software further causes the processor to carry out the steps comprising:
providing a first drop down box on the website to identify an organization who referred a user to the fundraising website.

18. The computer useable medium according to claim 15, wherein said fundraiser software further causes the processor to carry out the steps comprising:
providing a second drop down box to presents the user with a list of local chapters associated with the organization.

19. The computer useable medium according to claim 15, wherein said selling at least one of products and services step further comprises:
selling a product on the fundraising website for the fundraiser.

20. The computer useable medium according to claim 15, wherein said selling at least one of products and services step further comprises:
selling a service on the fundraising website for the fundraiser.
